(19) United States
(12) Patent Application Publication
(10) Pub. No.: US 2026/0175575 A1
(43) Pub. Date: Jun. 25, 2026

(54) LIQUID EJECTING HEAD

(71) Applicant: SEIKO EPSON CORPORATION, Tokyo (JP)

(72) Inventors: Motoki TAKABE, SHIOJIRI-SHI (JP); Takeru HATO, MATSUMOTO-SHI (JP)

(21) Appl. No.: 19/426,556

(22) Filed: Dec. 19, 2025

(30) Foreign Application Priority Data
Dec. 24, 2024 (JP) 2024-226919

(51) Int. Cl. B41J 2/14

(52) U.S. Cl. CPC B41J 2/14233; B41J 2/1433; B41J 2002/14241; B41J 2002/14491

(57) ABSTRACT

A liquid ejecting head includes a pressure chamber substrate having a pressure chamber space defined by a side wall, a diaphragm, and a piezoelectric element in which a lower electrode, a piezoelectric layer, and an upper electrode are stacked in this order. In a connecting portion where the diaphragm comes into contact with a first side wall serving as a side wall existing in a first direction, an extension portion is formed toward an inside of the pressure chamber space with a surface of the side wall as a reference, and when the pressure chamber is viewed in plan view from the diaphragm side, a first region in which the piezoelectric layer is not provided overlaps with a second side wall existing in a second direction intersecting with the first direction, and does not overlapping with a leading end portion of the extension portion.

The present application is based on, and claims priority from JP Application Serial Number 2024-226919, filed December 24, 2024, the disclosure of which is hereby incorporated by reference herein in its entirety.

### BACKGROUND

### 1. Technical Field

The present disclosure relates to a liquid ejecting head that ejects a liquid.

### 2. Related Art

As disclosed in JP-A-2013-158909, there is known a technique of a liquid ejecting head that ejects a liquid from a nozzle by applying a pressure fluctuation to the liquid in a pressure chamber. The pressure fluctuation is generated by driving an actuator formed on a diaphragm that forms one surface of the pressure chamber. As the actuator, a piezoelectric element in which electrodes are provided on both sides of a piezoelectric layer is used. When a voltage signal is applied between the electrodes interposing the piezoelectric layer therebetween, the piezoelectric element is distorted, and this distortion causes a pressure fluctuation in the pressure chamber via the diaphragm.

When the diaphragm vibrates due to the deformation of the piezoelectric element, stress caused by the vibration acts on the diaphragm, and a defect such as a crack may occur in the diaphragm. Therefore, as illustrated in JP-A-2019-111738, it has been proposed to prevent an occurrence of damage due to concentration of stress by providing a recessed portion in a portion of the diaphragm where the stress concentrates.

However, depending on the shape of the pressure chamber, the diaphragm may be broken or cracked at a corner portion of the pressure chamber. The inventors have studied the configuration of the corner portion of the pressure chamber and have found a configuration that further suppresses the occurrence of breakage or cracking in the diaphragm.

### SUMMARY

The present disclosure can be realized as the following aspects or application examples. One of the aspects is an aspect as a liquid ejecting head. For example, the liquid ejecting head may be a liquid ejecting head that ejects a liquid from a nozzle by a fluctuation of pressure in a pressure chamber, the liquid ejecting head including a pressure chamber substrate having a pressure chamber space defined by a side wall, a diaphragm constituting one surface of the pressure chamber by overlapping with the pressure chamber substrate and covering at least a portion of the pressure chamber space, and a piezoelectric element including stacking of a lower electrode, a piezoelectric layer, and an upper electrode in order, the piezoelectric element being disposed on a side of the diaphragm opposite to the pressure chamber space, in which in a connecting portion where the diaphragm comes into contact with a first side wall serving as a side wall existing in a first direction that is a longitudinal direction of the pressure chamber space, an extension portion is formed toward an inside of the pressure chamber space with a surface of the side wall as a reference, and when the pressure chamber is viewed in plan view from the diaphragm side, a first region in which the piezoelectric layer is not provided overlaps with a second side wall serving as a side wall existing in a second direction intersecting with the first direction, and the first region does not overlaps with a leading end portion of the extension portion.

### BRIEF DESCRIPTION OF THE DRAWINGS

FIG. 1 is a perspective view for explaining a configuration of a printer including a liquid ejecting head according to an embodiment.

FIG. 2 is an exploded perspective view of a portion of the liquid ejecting head.

FIG. 3 is an explanatory view for explaining details of a pressure chamber and a flow path.

FIG. 4 is a schematic view illustrating a configuration of a main portion of the liquid ejecting head by a cross-section in a longitudinal direction of the pressure chamber.

FIG. 5 is a sectional view taken along line V-V in FIG. 4.

FIG. 6 is an explanatory view of the liquid ejecting head in plan view from a side of a diaphragm overlapping with one surface of the pressure chamber.

FIG. 7 is an explanatory view schematically illustrating an aspect of an extension portion existing in a side wall of the pressure chamber.

FIG. 8 is a sectional view taken along line VIII-VIII in FIG. 7.

FIG. 9 is an explanatory plan view illustrating a positional relationship between an opening portion as a first region and each portion.

FIG. 10 is a view taken along line X-X in FIG. 9.

FIG. 11 is a view taken along line XI-XI in FIG. 9.

FIG. 12 is a view taken along line XII-XII in FIG. 9.

FIG. 13 is an explanatory view illustrating a positional relationship between the side wall and an active portion.

FIG. 14 is an explanatory view exemplifying a configuration in which the diaphragm bulges downward in the liquid ejecting head.

FIG. 15 is an explanatory view illustrating another example of the positional relationship between the side wall and the active portion.

FIG. 16 is an explanatory plan view illustrating a configuration around a pressure chamber according to a second embodiment.

FIG. 17 is an explanatory sectional view illustrating the configuration around the pressure chamber according to the second embodiment.

FIG. 18 is an explanatory view exemplifying a configuration in which the pressure chamber and a nozzle are connected via a communication substrate.

### DESCRIPTION OF EMBODIMENTS

### A. First Embodiment

Hereinafter, embodiments for implementing the present disclosure will be described with reference to the drawings. In the embodiments described below, various limitations are made as preferred specific examples of the present disclosure. However, the scope of the present disclosure is not limited to these aspects unless otherwise stated to limit the disclosed content in the following description. For example, in the following description, an ink jet head that ejects ink and an ink jet printer (hereinafter, referred to as a printer) in which the ink jet head is mounted will be described as an example of the liquid ejecting head, but the liquid to be ejected is not limited to ink, and may be various liquids such as water, alcohol, oil, and chemicals, or a suspension in which fine particles of a conductor such as a pigment or metal powder are suspended in these liquids. In addition, in the present specification, sending out a liquid from a nozzle or the like to the outside is referred to as "ejecting". The ejecting includes various aspects in which a predetermined amount of liquid is ejected to the outside, such as ejection, jetting, spraying, discharge, and intermittent ejecting, regardless of the type of liquid, the ejecting time, the number of times, and the like.

### A1 Configuration of Printer

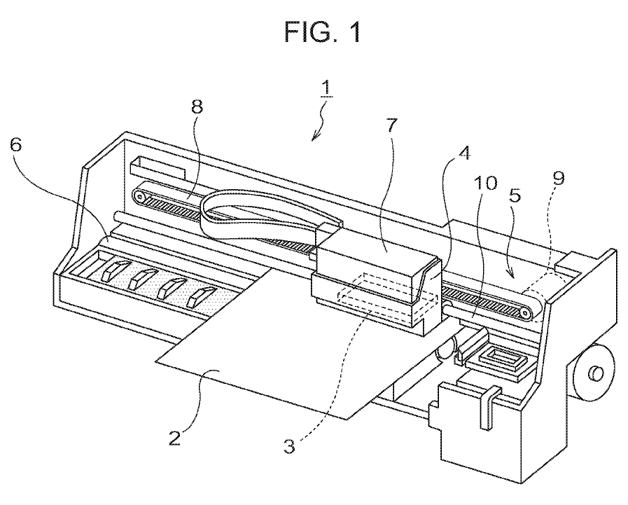

Prior to the description of a liquid ejecting head 3, a configuration of a printer 1 will be described with reference to FIG. 1. The printer 1 is an apparatus that records an image or the like by ejecting liquid ink onto a surface of a recording medium 2 such as recording paper. The printer 1 includes the liquid ejecting head 3, a carriage 4 to which the liquid ejecting head 3 is attached, a carriage moving mechanism 5 that moves the carriage 4 in a main scanning direction, a transport mechanism 6 that transports the recording medium 2 in a sub-scanning direction, and the like. Here, the above-described ink is a kind of liquid and is stored in an ink cartridge 7 as a liquid supply source. The ink cartridge 7 is detachably attached to the liquid ejecting head 3. It is possible to adopt a configuration in which the ink cartridge is disposed on a main body side of the printer, and the ink is supplied from the ink cartridge to a recording head through an ink supply tube.

The above-described carriage moving mechanism 5 includes a timing belt 8. The timing belt 8 is driven by a pulse motor 9 such as a direct current (DC) motor. Therefore, when the pulse motor 9 is operated, the carriage 4 is guided by a guide rod 10 installed in the printer 1 and reciprocates in the main scanning direction (a width direction of the recording medium 2).

### A2 Configuration of Liquid Ejecting Head

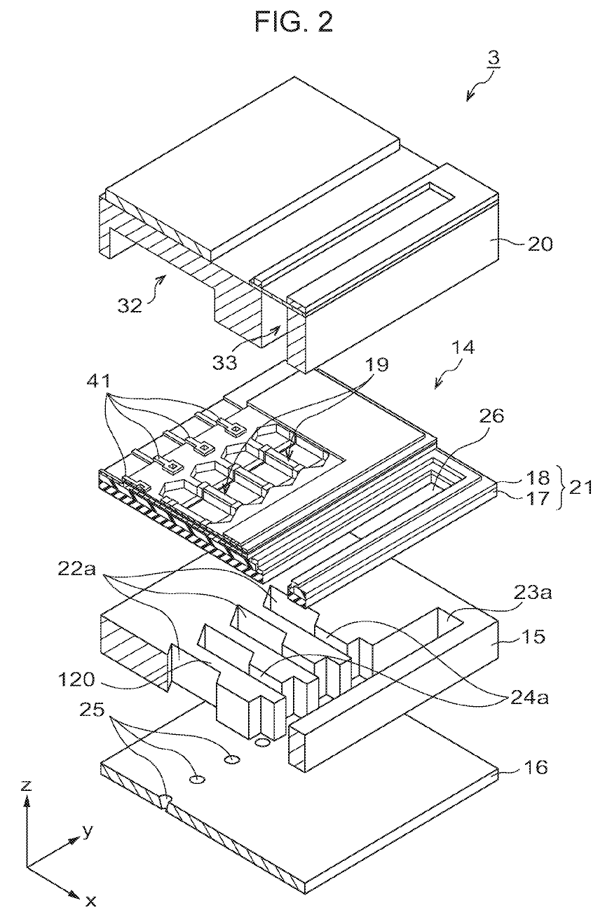

As illustrated in FIG. 2, the liquid ejecting head 3 according to a first embodiment is configured by stacking, in order from the bottom, a nozzle plate 16 in which a plurality of nozzles is formed, a pressure chamber substrate 15 in which a pressure chamber space 22a to be described later, and the like are formed, an actuator unit 14 including a diaphragm 21 at the bottom, a sealing plate 20 that seals the actuator unit 14, and the like. As indicated in the figure, a stacking direction here is referred to as a z direction. In addition, an arrangement direction of a plurality of nozzles 25 provided in the nozzle plate 16 is referred to as a y direction, and a direction orthogonal thereto is referred to as an x direction. In the present specification, the x direction may be referred to as a first direction, and the y direction may be referred to as a second direction. The directions x, y, and z are appropriately illustrated in the other figures.

The pressure chamber substrate 15 is, for example, a plate member made of a silicon single crystal substrate or the like. In the pressure chamber substrate 15, the plurality of the pressure chamber spaces 22a, a plurality of flow path spaces 24a, and a communication portion space 23a are formed. The pluralities of the pressure chamber spaces 22a and flow path spaces 24a are arranged side by side with partitions 120 interposed therebetween. Each pressure chamber space 22a is connected to a corresponding one of the flow path spaces 24a. In addition, the plurality of flow path spaces 24a is commonly connected to the communication portion space 23a.

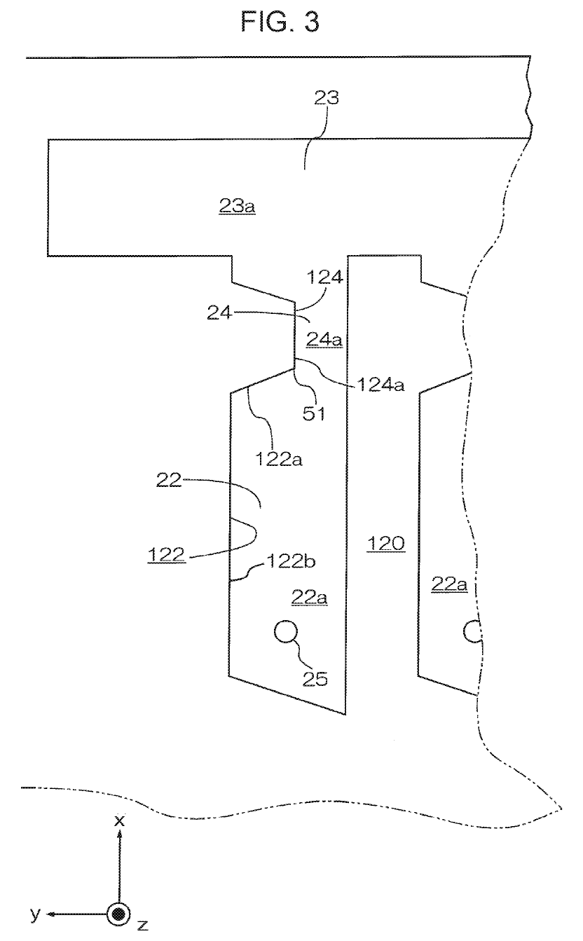

The partitions 120 separate the pluralities of pressure chamber spaces 22a and flow path spaces 24a. As illustrated in FIG. 3, each partition 120 is present between adjacent pressure chambers 22 and flow paths 24, and side surfaces of the partition 120 in the x and y directions illustrated in the figure and in opposite directions thereof function as side walls for the pressure chambers 22 and the flow paths 24. In other words, pressure chamber spaces 22a are each defined by four side walls. The pressure chamber spaces 22a and the flow path spaces 24a defined by the side walls are stacked on the nozzle plate 16 and the diaphragm 21 to form the pressure chambers 22 and the flow paths 24, respectively. Similarly, the communication portion space 23a forms a communication portion 23. Among these side walls, the side wall forming each pressure chamber 22 is referred to as a pressure chamber side wall 122, and the side wall forming each flow path 24 is referred to as a flow path side wall 124. Unless otherwise specified, the x direction indicates a direction from the pressure chamber space 22a toward the flow path space 24a as illustrated in the figure. When a direction opposite to the x direction is specified, the x direction may be described as a -x direction. Similarly, the y direction and the z direction are also described as a -y direction and a -z direction, respectively, when directions opposite to the illustrated directions are specified.

The pressure chamber 22 is the pressure chamber space 22a surrounded by the pressure chamber side walls 122 and is a space surrounded by the nozzle plate 16 at a lower portion thereof and by the diaphragm 21 at an upper portion thereof. Similarly, the flow path 24 is the flow path space 24a surrounded by the flow path side walls 124 and is a space surrounded by the nozzle plate 16 at a lower portion thereof and by the diaphragm 21 at an upper portion thereof. The plurality of flow paths 24 is connected to the communication portion 23, and these spaces are filled with ink when the liquid ejecting head 3 is used. In the following description, the pressure chamber 22 and the pressure chamber space 22a are referred to as the pressure chamber 22 when it is not particularly necessary to distinguish the pressure chamber 22 and the pressure chamber space 22a. The same applies to the flow path 24 and the communication portion 23.

In the present embodiment, the pressure chamber space 22a has a substantially trapezoidal shape in plan view in the z direction and is surrounded by four pressure chamber side walls 122. Among the four pressure chamber side walls 122, the side wall forming a corner portion 51 together with the flow path side wall 124 on the flow path 24 side is referred to as a first pressure chamber side wall 122a. The first pressure chamber side wall 122a is a side wall existing in the x direction, which is the first direction, in the pressure chamber 22. In addition, the side wall existing in the second direction (the y direction) intersecting with (here, orthogonal to) the first direction is referred to as a second pressure chamber side wall 122b. Pressure chamber side walls other than the first pressure chamber side wall 122a and the second pressure chamber side wall 122b may be simply referred to as the pressure chamber side walls 122. Similarly, the side wall on the flow path 24 side that forms the corner portion 51 together with the first pressure chamber side wall 122a is referred to as a first flow path side wall 124a and may be distinguished from other side walls.

The partition 120 of the pressure chamber substrate 15 defines the pressure chamber 22 as the pressure chamber side wall 122 and defines the flow path 24 as the flow path side wall 124, and these side walls form the corner portion 51 at a connection portion where the pressure chamber 22 and the flow path 24 are connected to each other. Therefore, the corner portion 51 is a portion where two side walls protrude to the pressure chamber 22 side or the flow path 24 side, that is, outward when viewed from the partition 120. In this case, the first pressure chamber side wall 122a and the first flow path side wall 124a form an angle larger than 180°. Of course, the corner portion 51 is not limited to being formed by two adjacent side walls, and may be provided as a bent portion in which a side wall connecting the pressure chamber 22 and the flow path 24 is bent so as to protrude outward. The corner portion 51 may be a sharp edge sharpened to the manufacturing limit, or may be provided with a predetermined chamfer or curved surface (R).

The pressure chamber 22 is a space elongated in the first direction and is provided in one-to-one correspondence with each nozzle 25 of the nozzle plate 16. That is, the pressure chambers 22 are formed in a nozzle row direction at the same pitch as the formation pitch of the nozzles 25. The pressure chamber substrate 15 of the present embodiment is formed by performing anisotropic etching on a silicon single crystal substrate having a plane orientation (110). Therefore, an upper opening (opening on a side opposite to the nozzle 25 side) of the pressure chamber 22 has a trapezoidal shape. An example of the dimensions of the pressure chamber 22 is as follows, but the dimensions are not limited thereto. A dimension of the upper opening of the pressure chamber 22 in the first direction (the x direction) is set to approximately 360 μm, a width of the upper opening of the pressure chamber 22, that is, the dimension in the second direction (the y direction) is set to approximately 70 μm, and a height of the pressure chamber 22 in the z direction, that is, a thickness of the pressure chamber substrate 15 is set to approximately 70 μm. The dimension of the upper opening of the pressure chamber 22 in the first direction (the x direction) may be set to approximately 300 to 2000 μm, the dimension of the width of the upper opening of the pressure chamber 22 may be set to approximately 20 to 200 μm, and the height of the pressure chamber 22 in the z direction may be set to approximately 30 to 200 μm.

As illustrated in FIG. 2, in the pressure chamber substrate 15, the communication portion space 23a that extends through the pressure chamber substrate 15 is formed in a direction in which the pressure chamber spaces 22a are arranged side by side in a region that deviates from the flow path spaces 24a in the x direction. The communication portion 23 formed by the communication portion space 23a is a space portion common to each pressure chamber 22 and flow path 24. The communication portion 23 and each pressure chamber 22 are in communication with each other with the flow path 24 interposed therebetween. The communication portion 23 is in communication with a communication opening portion 26 of the diaphragm 21 and a liquid chamber space portion 33 of the sealing plate 20 to be described later and configures a reservoir, which is a common liquid chamber, which is an ink chamber common to each pressure chamber 22. The flow path space 24a is formed to be narrower than the pressure chamber space 22a, and the flow path 24 serves as a flow path resistance against the ink flowing from the communication portion 23 into the pressure chamber 22.

The pressure chamber substrate 15 and the nozzle plate 16 are bonded to each other with an adhesive, a thermal welding film, or the like interposed therebetween. In the nozzle plate 16 of the present embodiment, the respective nozzles 25 are arranged side by side at a pitch corresponding to dot formation densities, for example, 300 dpi, where the pitch refers to the distance between the centers of adjacent nozzles 25. Each nozzle 25 is in communication with an end portion of the pressure chamber 22 on a side opposite to the flow path 24. The nozzle plate 16 is formed using, for example, glass ceramics, a silicon single crystal substrate, a polyimide-based photosensitive resin, stainless steel, or the like.

In the actuator unit 14 stacked on the pressure chamber substrate 15, a plurality of piezoelectric elements 19 corresponding to the respective pressure chambers 22 is provided on an upper surface in the z direction of the diaphragm 21 constituting the upper surface of the pressure chamber 22, that is, on a side of the diaphragm 21 opposite to the pressure chamber 22. The diaphragm 21 includes an elastic film 17 on the pressure chamber substrate 15 side and an insulator film 18 formed on the elastic film 17. As the elastic film 17, for example, silicon dioxide (SiO₂) having a thickness of 300 to 2000 nm is suitably used. As the insulator film 18, for example, zirconium oxide (ZrOₓ) having a thickness of 30 to 600 nm is suitably used. A portion of the diaphragm 21 corresponding to the pressure chamber 22, that is, a portion which blocks an upper opening of the pressure chamber space 22a and defines a portion of the pressure chamber 22 functions as a displacing portion which is displaced in a direction away from the nozzle 25 or a direction close to the nozzle 25 according to the flexural deformation of the piezoelectric elements 19. The communication opening portion 26 in communication with the communication portion 23 is provided in a portion of the diaphragm 21 corresponding to the communication portion 23 of the pressure chamber substrate 15.

### A3 Configuration of Piezoelectric Element

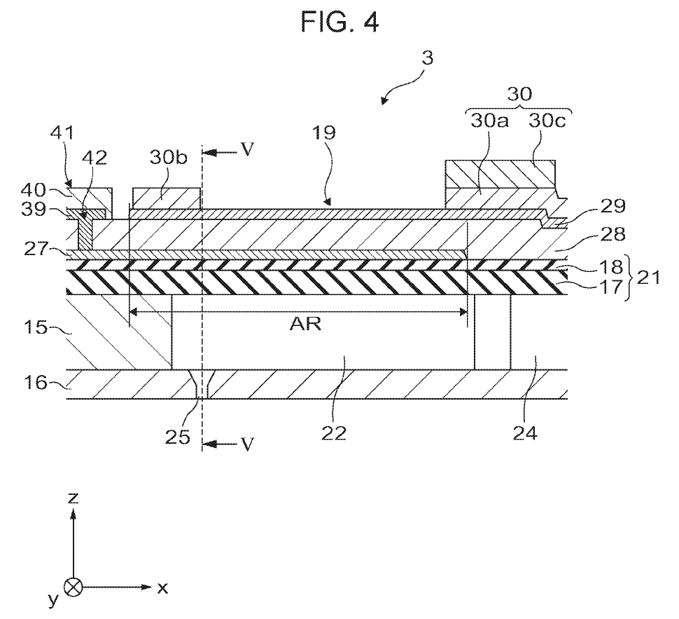

Next, the structure of each piezoelectric element 19 formed in the actuator unit 14 will be described with reference to FIGS. 4 to 6. In the piezoelectric element 19 according to the present embodiment, a lower electrode 27, a piezoelectric layer 28, and an upper electrode 29 are stacked in order from the diaphragm 21 side by a film formation technique. As the upper electrode 29 and the lower electrode 27, various metals such as iridium (Ir), platinum (Pt), titanium (Ti), tungsten (W), tantalum (Ta), and molybdenum (Mo), alloys thereof, and the like are used. As the piezoelectric layer 28, a ferroelectric piezoelectric material such as lead zirconate titanate (PZT), a relaxor ferroelectric obtained by adding a metal such as niobium, nickel, magnesium, bismuth, or yttrium to the ferroelectric piezoelectric material, or the like is used.

An example of the thickness of each layer is indicated below. The thickness of the upper electrode 29 can be set in a range of 15 to 100 nm, the thickness of the piezoelectric layer 28 (more specifically, the thickness of the piezoelectric layer 28 in a portion interposed between the upper electrode 29 and the lower electrode 27) can be set in a range of 0.7 to 5 μm, and the thickness of the lower electrode 27 can be set in a range of 50 to 300 nm. Of course, an appropriate dimension may be set depending on the material used for each portion and the function to be realized. The thickness of each portion of the piezoelectric element 19 will be described in detail later, including the thickness of a protective film to be described later.

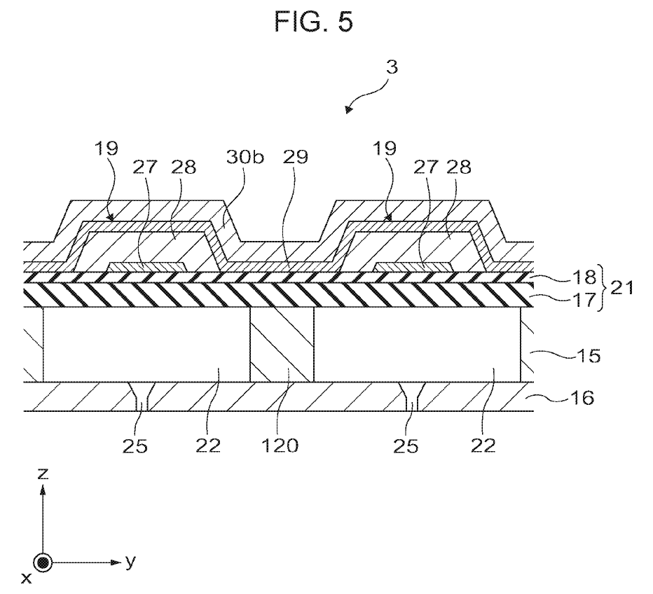

In the present embodiment, as illustrated in FIG. 5, the lower electrode 27 is provided independently for each pressure chamber 22, while the upper electrode 29 is provided continuously over a plurality of the pressure chambers 22. Therefore, the lower electrode 27 serves as an individual electrode for each pressure chamber 22, and the upper electrode 29 serves as a common electrode common to the respective pressure chambers 22.

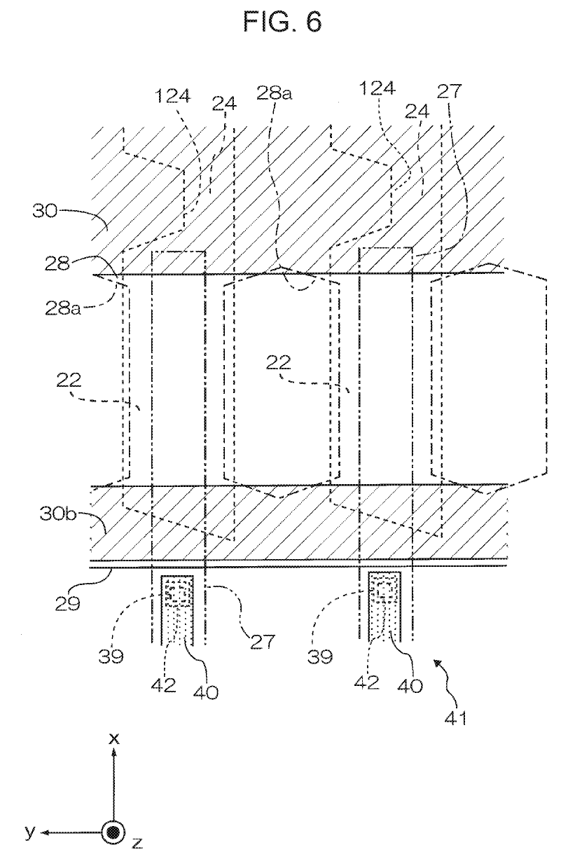

As illustrated in FIGS. 5 and 6, the width of the lower electrode 27 in the second direction (the y direction) is smaller than the width of the pressure chamber 22 (more specifically, the upper opening of the pressure chamber spaces 22a) and the width of the piezoelectric layer 28 in a region corresponding to the pressure chamber 22 (a distance between adjacent opening portions 28a to be described later). In addition, as illustrated in FIG. 6, in the first direction (the x direction) which is the longitudinal direction of the pressure chamber 22, the end portion of the lower electrode 27 on the flow path 24 side does not overlap with the portion of the side wall 122 constituting the end portion of the pressure chamber 22 in plan view (-z direction view). The state of overlapping between the lower electrode 27 and the side wall 122 and other ways of overlapping will be described in detail later. On the other hand, as illustrated in FIG. 4, the end portion on the other side (the -x direction) of the lower electrode 27 is extended to a lead electrode portion 41.

In the second direction (the y direction), both end portions of the upper electrode 29 extend to the outside of a group of the pressure chambers 22 arranged in parallel. In addition, as illustrated in FIG. 4, in the first direction (the x direction) which is the longitudinal direction of the pressure chamber 22, an end portion of the upper electrode 29 on one side extends beyond an end portion of the lower electrode 27 to the outside, and an end portion on the other side (the -x direction) extends beyond an end portion of the pressure chamber 22 to a region between the pressure chamber 22 and the lead electrode portion 41.

The piezoelectric layer 28 interposed and stacked between the upper electrode 29 and the lower electrode 27 extends to the outside beyond both end portions of the pressure chamber 22 in the longitudinal direction and is formed over the plurality of pressure chambers 22. In addition, the plurality of the opening portions 28a in which the piezoelectric layer 28 is partially removed is formed in regions corresponding to portions between the adjacent pressure chambers 22. That is, the plurality of opening portions 28a is formed at the same pitch as the formation pitch of the pressure chambers 22 (the formation pitch of the nozzles 25) in the second direction (the y direction) which is the nozzle row direction. In other words, the piezoelectric elements 19 each corresponding to one pressure chamber 22 are formed between one opening portion 28a and one opening portion 28a at the same pitch as the formation pitch of the pressure chambers 22. The width of the piezoelectric layer 28 in the nozzle row direction above the pressure chamber space 22a (a distance between the adjacent opening portions 28a) is smaller than the width of the pressure chamber 22 in the same direction and larger than the width of the lower electrode 27 in the same direction. In addition, as illustrated in FIG. 6, the length of the opening portion 28a in the longitudinal direction is formed to be shorter than the length of the pressure chamber 22 in the longitudinal direction (the x direction). That is, in the longitudinal direction, the end portions of the opening portion 28a on both sides are located further on the inner side (on the center side of the pressure chamber 22) than are the end portions of the pressure chamber 22 on both sides. The opening portion 28a of the present embodiment is formed in an elongated hexagonal shape which is long in the longitudinal direction of the pressure chamber 22 in plan view. In addition, in the longitudinal direction of the pressure chamber 22, the piezoelectric layer 28 in a region deviated from the opening portion 28a is continuously formed over the plurality of pressure chambers 22.

As illustrated in FIG. 5, the width (dimension in the y direction) of each portion of the piezoelectric element 19 decreases in the order of the width of the upper electrode 29, the width of the pressure chamber 22, the width of the piezoelectric layer 28, and the width of the lower electrode 27 in a region corresponding to the pressure chamber 22. When a voltage is applied between the lower electrode 27 and the upper electrode 29, a range of the piezoelectric layer 28 interposed between the lower electrode 27 and the upper electrode 29 is distorted to cause displacement of the piezoelectric element 19. This range is referred to as an active portion AR. As illustrated in FIGS. 4 and 5, the active portion AR is a range where the upper electrode 29 and the lower electrode 27 overlap with each other in the first direction (the x direction) and is substantially equal to the width of the lower electrode 27 in the second direction (the y direction).

As described above, the opening portion 28a is a region where neither the piezoelectric layer 28 nor the lower electrode 27 is present and corresponds to a first region. Therefore, although the upper electrode 29 is present above the diaphragm 21, the opening portion 28a functions as an arm portion that facilitates deformation of the diaphragm 21 when the active portion AR of the piezoelectric element 19 is driven by a drive signal.

In an end portion region of the piezoelectric element 19 in the first direction (the x direction) which is the longitudinal direction of the pressure chamber 22, a protective film 30 which is continuous over the plurality of pressure chambers 22 is stacked. The protective films 30 are provided on both end portions of the piezoelectric elements 19. When the protective films 30 are distinguished from each other, the protective film 30 formed in an end portion region in the first direction (the x direction), that is, on the flow path 24 side is referred to as the protective film 30, and the protective film 30 formed in an end portion region on the opposite side is referred to as a protective film 30b. The protective film 30 includes a stress relieving film 30a corresponding to a first protective film and a regulating film 30c stacked thereon. Since the protective film 30b is formed using the same material as the stress relieving film 30a, the protective film 30b may be referred to as a stress relieving film 30b in the following description. Each of the stress relieving films 30a and 30b is a metal film (for example, NiCr) and is stacked on the upper electrode 29. The regulating film 30c is a film (for example, Au) having a higher rigidity than that of the stress relieving films 30a and 30b. In the present embodiment, the protective film is continuously formed over the plurality of pressure chambers 22 and is formed on both sides interposing the opening portions 28a therebetween in the first direction (the x direction).

The stress relieving films 30a and 30b can be formed of a metal or a nonmetal. In addition to NiCr used in the present embodiment, various metals such as TiW and Pt, as well as Ni, Al, Cu, Au, Ti, W, and Ir can be used, for example. In addition, various oxides and nitrides can be used as the nonmetal, and for example, TaOₓ, AlOₓ, SiNₓ, SiO₂, ITO, TiO₂, ZrO₂, CrOₓ, and the like can also be used. The regulating film 30c is formed using a material having a higher rigidity than that of the stress relieving film 30a which is the first protective film. A typical material is Au.

The protective film 30 formed on the flow path 24 side extends from a region outside the pressure chamber 22 and the flow path 24 to a region corresponding to an end portion of the opening portion 28a. On the other hand, the stress relieving film 30b on the opposite side (the nozzle 25 side) of the piezoelectric element 19 in the first direction (the x direction) extends from a region corresponding to the end portion on the other side of the opening portion 28a to a region between the pressure chamber 22 and the lead electrode portion 41 beyond the end portion of the pressure chamber 22. The regulating film 30c for regulating the displacement of the piezoelectric element 19 may be provided on the stress relieving film 30b.

As illustrated in FIG. 6, the protective film 30 on one side is overlapped with an end portion including an apex on one side of the opening portion 28a having an elongated hexagonal shape in plan view and is overlapped with an end portion of the pressure chamber 22 including a boundary with the flow path 24. In addition, the stress relieving film 30b on the other side is overlapped with an end portion of the opening portion 28a including an apex on the other side in plan view and is overlapped with an end portion of the pressure chamber 22 on the other side. By overlapping the protective film 30 and the opening portion 28a in the first direction (the x direction) which is the longitudinal direction of the pressure chamber 22, the rigidity of the piezoelectric element 19 in regions corresponding to end portions of the pressure chamber 22 is increased without excessively suppressing the deformation of the piezoelectric element 19.

The lower electrode 27 individually formed for each pressure chamber 22 is energized via the lead electrode portion 41. As illustrated in FIGS. 4 and 6, the lead electrode portion 41 is formed at a position outside an end portion of the pressure chambers 22 on the nozzle 25 side and outside the stress relieving film 30b. In the lead electrode portion 41, a through hole 42 extending from an upper surface of the piezoelectric layer 28 to the lower electrode 27 is formed so as to pass through the piezoelectric layer 28. In a region corresponding to the through hole 42, an upper electrode film for conduction 39 is formed slightly larger than the through hole 42. The upper electrode film for conduction 39 is individually patterned corresponding to the through hole 42 and is conducted to the lower electrode 27 which is an individual electrode through the through hole 42. On the upper electrode film for conduction 39, an individual metal layer 40 is patterned corresponding to the lower electrode 27 (the through hole 42). With such a structure, the individual metal layer 40 is conducted to the lower electrode 27 via the upper electrode film for conduction 39 formed in the region corresponding to the through hole 42. The individual metal layer 40 (the lead electrode portion 41) extends to a terminal region (not illustrated) and is electrically connected to an individual electrode terminal of a wiring member. The lower electrode 27 is covered with the piezoelectric layer 28 except for a range corresponding to the through hole 42. As a result, a leakage current from the lower electrode 27 can be suppressed as much as possible, and it is possible to save the trouble of taking special measures for suppressing the leakage current (for example, protection by a protective film of aluminum oxide or the like). Of course, a protective film may be provided.

As illustrated in FIG. 2, the actuator unit 14 is bonded to the pressure chamber substrate 15 on a lower side (the -z direction) and is bonded to the sealing plate 20 having an accommodation space portion 32 capable of accommodating the piezoelectric element 19 on an upper side (the z direction). In the sealing plate 20, the liquid chamber space portion 33 is provided in a region corresponding to the communication opening portion 26 of the diaphragm 21 and the communication portion 23 of the pressure chamber substrate 15 at a position outside the accommodation space portion 32 in the x direction. The liquid chamber space portion 33 extends through the sealing plate 20 in a thickness direction and is provided in a direction (the y direction) in which the pressure chambers 22 are arranged side by side. As described above, the liquid chamber space portion 33 is in communication with the communication opening portion 26 and the communication portion 23 in series to define a reservoir serving as a common ink chamber for the pressure chambers 22. Although not illustrated, the sealing plate 20 is provided with a wiring opening portion, in addition to the accommodation space portion 32 and the liquid chamber space portion 33. The wiring opening portion extends through the sealing plate 20 in the thickness direction at a position corresponding to the terminal region of the actuator unit 14. The individual metal layer 40 and the protective film 30 of the terminal region are exposed in the wiring opening portion. Terminals of a wiring member (not illustrated) from the printer main body side are electrically connected to the exposed portions of the protective film 30 and the metal layer 40.

In the liquid ejecting head 3 having the above-described configuration, the ink is taken in from the ink cartridge 7, and the liquid chamber space portion (reservoir) 33, the flow path 24, the pressure chamber 22, and the flow path to the nozzle 25 are filled with the ink. By supply of the drive signal from the printer main body side, a drive voltage is applied to each piezoelectric element 19 corresponding to the pressure chamber 22 at an appropriate timing. Since the drive voltage is applied between the lower electrode 27 and the upper electrode 29, an electric field corresponding to a potential difference between both electrodes is applied to the piezoelectric element 19, the piezoelectric element 19 is distorted, and the piezoelectric element 19 and the diaphragm 21 are displaced. As a result, a pressure fluctuation occurs in the pressure chamber 22, and the ink is ejected from the nozzle 25. By controlling the pressure fluctuation, an ink interface (meniscus) in the nozzle 25 is controlled, and an ink droplet having an appropriate size is ejected from the nozzle 25 toward the recording medium 2.

### A4 Configuration of Extension Portion and Positional Relationship Between Extension Portion and First Region

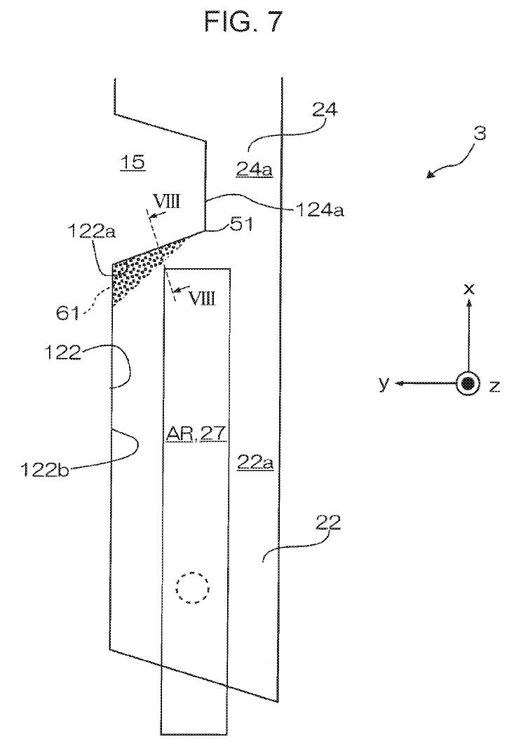

FIG. 7 is an explanatory diagram of the pressure chamber 22 in the liquid ejecting head 3 in plan view from the side of the diaphragm 21 covering the pressure chamber 22. In the figure, the diaphragm 21 is not illustrated, and the pressure chamber 22 and the flow path 24, which are defined by the side walls 122 and 124, and the lower electrode 27 are drawn to overlap with each other. In the present embodiment, as described above, the lower electrode 27 is the smallest among the lower electrode 27, the piezoelectric layer 28, and the upper electrode 29 that are stacked, and the lower electrode 27 and the active portion AR coincide with each other at the end portion in the x direction. Therefore, in the following description, arrangement of the active portion AR will be described with reference to the lower electrode 27.

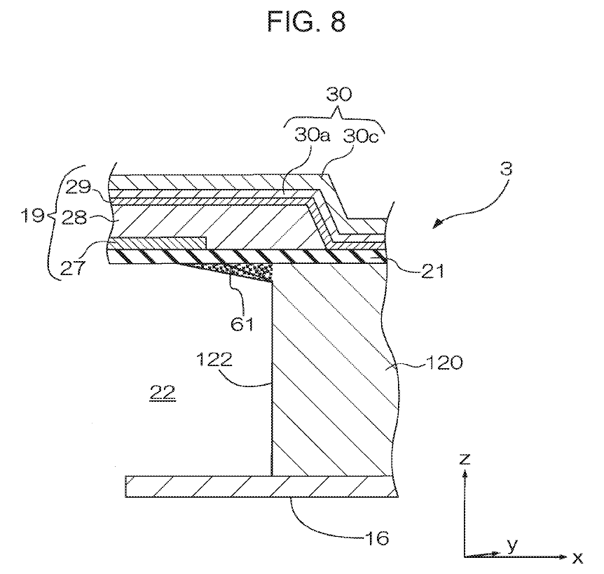

The liquid ejecting head 3 includes an extension portion 61 on the first pressure chamber side wall 122a that defines the flow path 24 side (the x direction side) of the pressure chamber 22. The shape of the extension portion 61 will be described with reference to FIG. 8 which is a sectional view taken along line VIII-VIII of FIG. 7. The sectional view taken along line VIII-VIII is a cross-section perpendicular to the first pressure chamber side wall 122a. As illustrated in the figures, the extension portion 61 is a portion extended toward an inside of the pressure chamber 22 along a surface of the diaphragm 21 at an upper end (an end portion in the z direction) of the first pressure chamber side wall 122a, that is, at an end portion in contact with the diaphragm 21. When the pressure chamber substrate 15 is formed by etching a silicon single crystal substrate, a portion which is intentionally left may be used as the extension portion 61, or the extension portion 61 may be formed as a remaining portion which is generated due to the progress speed of etching of a corner portion. By providing the extension portion 61 described above, it is possible to alleviate the pressure applied to the diaphragm 21 and the piezoelectric layer 28 in the vicinity of the extension portion 61.

In the illustrated embodiment, the extension portion 61 has a shape in which the thickness thereof is linearly gradually decreased as the distance from the pressure chamber side wall 122 increases, but the configuration is not limited thereto, and the extension portion 61 may have a shape in which the thickness is gradually decreased in a stepwise manner. In this case, the angle of the gradual decrease of each portion may be defined as, for example, the angle of a straight line connecting the lowermost position at which the extension portion 61 is in contact with the first pressure chamber side wall 122a and the uppermost position at which the extension portion 61 is in contact with the diaphragm 21. Alternatively, the angle of the gradual decrease may be represented by an angle near the middle point of the inclined shape. Of course, the extension portion 61 may be formed to have a uniform thickness.

As illustrated in the figure, in plan view of the pressure chamber 22, the active portion AR, which is a portion where the piezoelectric layer 28 is interposed between the lower electrode 27 and the upper electrode 29 in the piezoelectric element 19, that is, the lower electrode 27 here, is disposed at a position that does not overlap with the first pressure chamber side wall 122a or the corner portion 51 formed in a connecting portion to the flow path 24 in the first direction (the x direction), which is the longitudinal direction of the piezoelectric element 19. With this arrangement, the lower electrode 27 does not overlap with the corner portion 51 or the first pressure chamber side wall 122a. Therefore, even when the piezoelectric element 19 is deformed together with the diaphragm 21 by application of a drive voltage to the piezoelectric element 19, stress from the lower electrode 27 is not applied to the corner portion 51 or the first pressure chamber side wall 122a. For this reason, it is possible to suppress breakage or cracking in the piezoelectric element 19 from a portion corresponding to the corner portion 51 or the first pressure chamber side wall 122a.

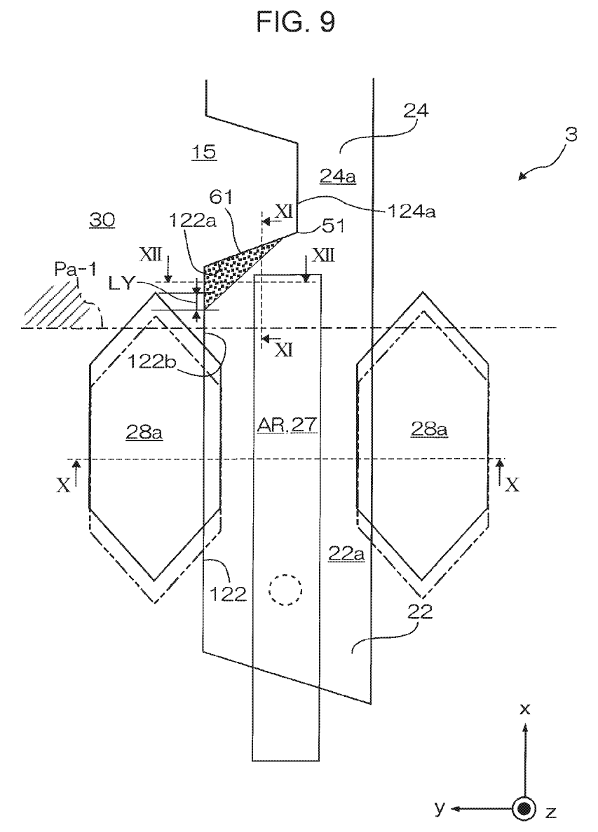

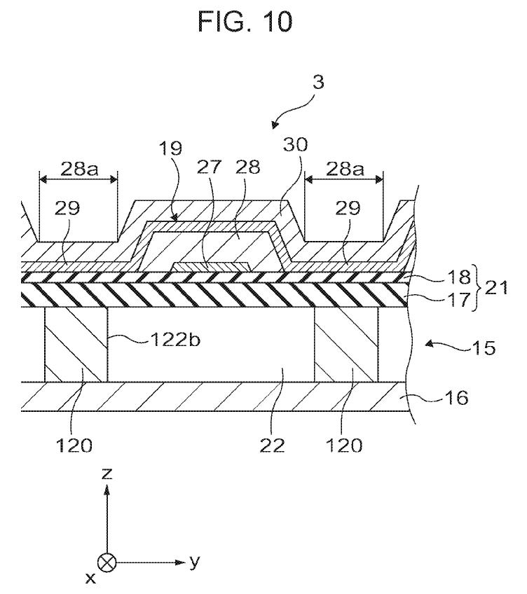

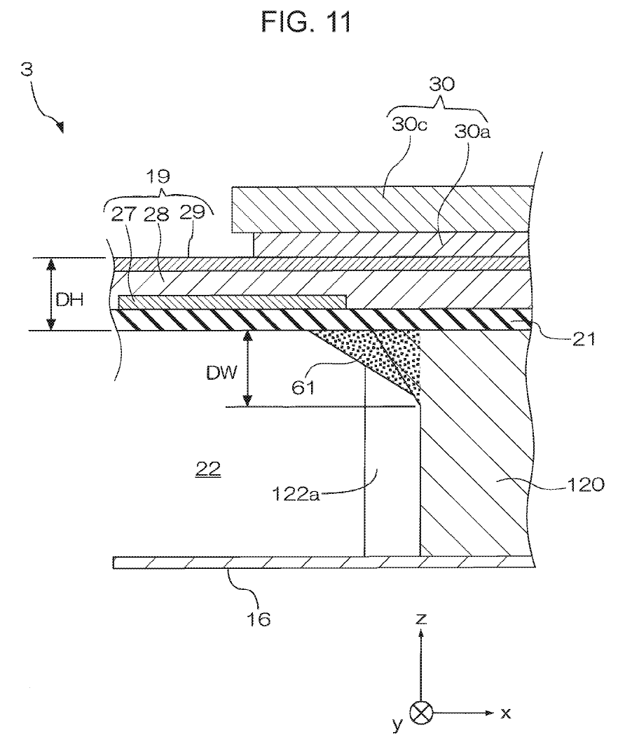

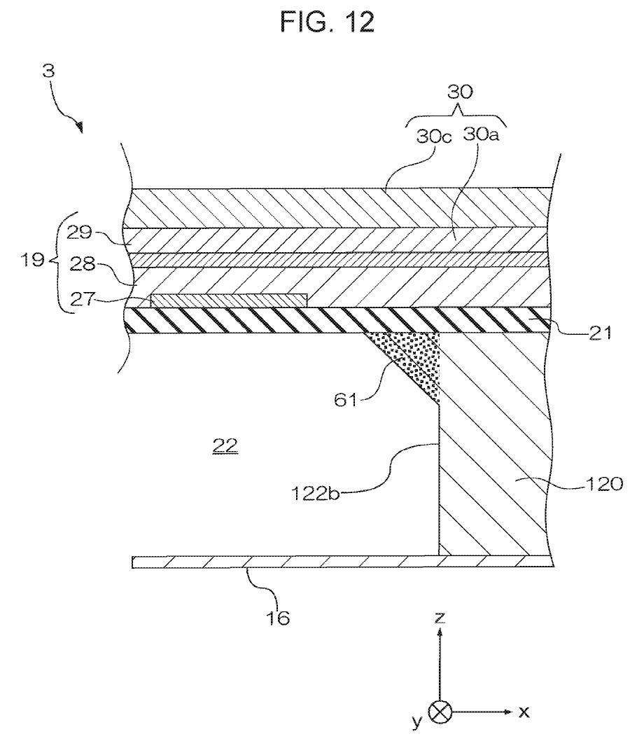

Next, a description will be given of a positional relationship between the opening portion 28a and the extension portion 61 existing on the first pressure chamber side wall 122a in the liquid ejecting head 3 of the present embodiment. FIG. 9 is an explanatory view illustrating the positional relationship between the opening portion 28a corresponding to the first region and the side walls defining the pressure chamber space 22a in plan view of the pressure chamber 22 from the diaphragm 21 side. FIG. 10 is a view taken along line X-X in FIG. 9, FIG. 11 is a view taken along line XI-XI in FIG. 9, and FIG. 12 is a view taken along line XII-XII in FIG. 9. The scales of the drawings are different from each other for convenience of explanation. Hereinafter, arrangement of members will be described with reference to the drawings as appropriate.

The piezoelectric element 19 is disposed at substantially the center of the pressure chamber 22 in the second direction (the y direction). In the present embodiment, the lower electrode 27 that defines the width of the active portion AR is narrower than the pressure chamber space 22a. The piezoelectric layer 28 is wider than the lower electrode 27. The piezoelectric layer 28 is provided for each of the piezoelectric elements 19 and over the adjacent piezoelectric elements 19 except for the opening portions 28a. On the other hand, since the upper electrode 29 is used as a common electrode, the upper electrodes 29 of the adjacent piezoelectric elements 19 are connected to each other. As a result, there is a region where neither the lower electrode 27 nor the piezoelectric layer 28 is present between the adjacent piezoelectric elements 19 and only the upper electrode 29 is in contact with the diaphragm 21. This is the substantially hexagonal opening portion 28a elongated in the first direction and corresponds to the first region.

As illustrated in the figure, when the pressure chamber 22 is viewed in plan view from the diaphragm 21 side, the opening portion 28a overlaps with a portion of the second pressure chamber side wall 122b which is present in the second direction (the y direction) among the pressure chamber side walls 122 defining the pressure chamber space 22a. Since the piezoelectric layer 28 does not exist on the diaphragm 21, the opening portion 28a is easily deformed. For this reason, when the piezoelectric element 19 is driven, the diaphragm 21 is largely bent at the opening portion 28a.

On the other hand, the opening portion 28a is disposed so as not to overlap with a leading end portion of the extension portion 61 in the first direction (the -x direction). Therefore, it is possible to suppress the occurrence of breakage or cracking in the diaphragm 21. This is because, when overlapping between the diaphragm 21 deformed by the piezoelectric element 19 and another member is discontinuous, a local tensile stress is applied to the diaphragm 21, and the risk of breakage of the diaphragm 21 may increase. According to the configuration of the present embodiment, the extension portion 61 and the opening portion 28a do not overlap with each other, and cracks or the like are thus less likely to occur in the diaphragm 21.

In addition, when the pressure chamber 22 is viewed in plan view from the diaphragm 21 side, the leading end portion of the extension portion 61 in the first direction (the -x direction) overlaps with the piezoelectric layer 28. Since the leading end portion of the extension portion 61 overlaps with the piezoelectric layer 28 as described above, the stress applied to the leading end portion of the extension portion 61 can be reduced.

In addition, in the present embodiment, since the upper electrode 29, which is a common electrode, widely covers the piezoelectric layer 28, the piezoelectric layer 28 is not exposed to the outside, is not easily affected by the external environment, and it is easy to realize high reliability, durability, and the like. When the upper electrode 29 is used as a common electrode as described above, the side wall 122 of the pressure chamber 22 and the like can be covered with the upper electrode 29 made of the same metal material, and it is easy to reduce the variation in the way the stress is applied. For this reason, a gap or the like is unlikely to be generated in each portion, and it is possible to suppress the possibility that moisture enters the inside of the piezoelectric element 19 from a gap.

### A5 Other Features That Can Be Included in Active Portion

### 1 Other Features 1

In the present embodiment, in a stacking direction of the pressure chamber substrate 15, the diaphragm 21, the piezoelectric element 19, and the like, a thickness DW of the extension portion 61 on the first pressure chamber side wall 122a is larger than a total thickness DH of the diaphragm 21 and the piezoelectric element 19. In the present embodiment, DW = 4 μm, and DH = 3 μm. As a result, since the thickness DW of the extension portion 61 is larger than the total thickness DH of the diaphragm 21 and the piezoelectric element 19, it is possible to relatively increase the rigidity of the extension portion 61 and to suppress the possibility that the diaphragm 21 is broken or cracked. Of course, DW ≤ DH may be satisfied.

### 2 Other Features 2

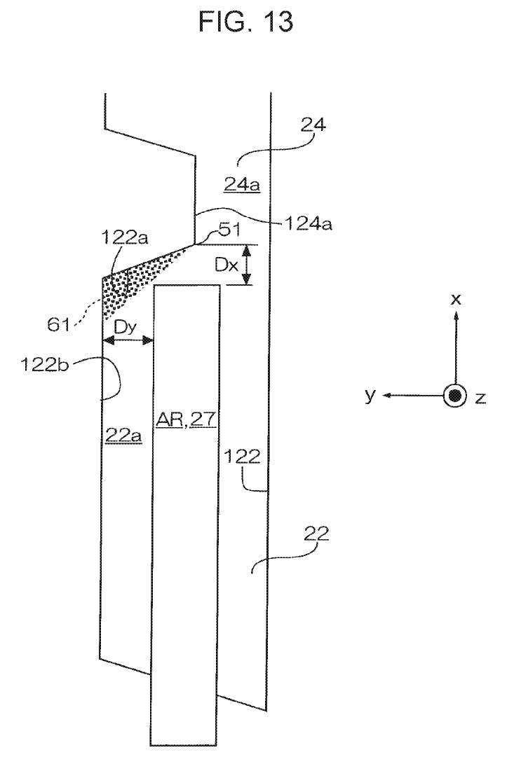

In the present embodiment, as illustrated in FIG. 13, with respect to the pressure chamber 22, the end portion of the lower electrode 27, which defines the active portion AR, in the first direction (the x direction) does not overlap with the first pressure chamber side wall 122a, and the side end portion of the lower electrode 27 in the second direction (the y direction) does not overlap with the second pressure chamber side wall 122b. Here, a separation distance Dx between the active portion AR and the first pressure chamber side wall 122a existing in the first direction is defined as the maximum separation distance between the end portion of the active portion AR in the first direction and the first pressure chamber side wall 122a. In this example, since the first pressure chamber side wall 122a is inclined at a predetermined angle toward the flow path 24, the distance between the corner portion 51 and the end portion of the active portion AR corresponds to the separation distance Dx. On the other hand, a separation distance Dy between the active portion AR and the second pressure chamber side wall 122b existing in the second direction is defined as the maximum separation distance between the side end portion of the active portion AR in the second direction and the second pressure chamber side wall 122b. In this example, since the second pressure chamber side wall 122b is parallel to the side end portion of the active portion AR, measurement may be performed at any position. Since the active portion AR is disposed at the center of the pressure chamber space 22a in the width direction (the y direction), the distance between the active portion AR and the pressure chamber side wall 122 in the -y direction is also equal to the separation distance Dy.

In the present embodiment, the separation distances Dx and Dy satisfy Dx < Dy. That is, when the pressure chamber 22 is viewed in plan view from the diaphragm 21 side, the separation distance Dy between the active portion AR and the second pressure chamber side wall 122b as the second side wall in the second direction is longer than the separation distance Dx between the active portion AR and the first pressure chamber side wall 122a as the first side wall in the first direction. Since the separation distance Dy is longer than the separation distance Dx, the piezoelectric element 19 can secure a displacement amount in the second direction (the y direction). Therefore, it is possible to secure the displacement amount of the diaphragm 21 and to improve the ejection performance of the ink from the nozzle 25. As long as the displacement amount can be secured, Dx ≥ Dy may be satisfied.

### 3 Other Features 3

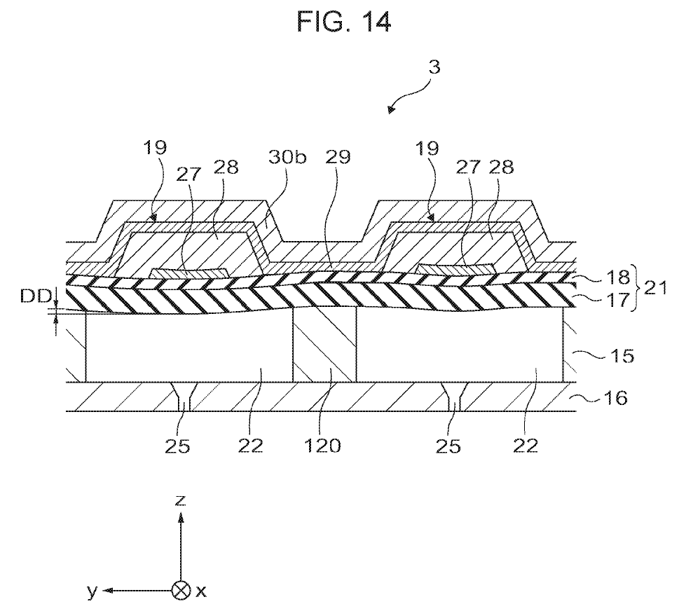

In the present embodiment, although the diaphragm 21 having a flat shape has been illustrated, but as illustrated in FIG. 14, in a non-operation state where a voltage is not applied to the piezoelectric element 19, the central portion of the diaphragm 21 may have a shape which bulges downward (the -z direction) by a length DD compared to the joint portion with the partition 120, that is, a projecting shape on the pressure chamber 22 side.

Since the diaphragm 21 is projecting downward, the extension portion 61 does not receive a force from the diaphragm 21 when the piezoelectric element 19 is not operated, and thus it is possible to improve reliability. Of course, the diaphragm 21 may have a flat shape or may have a projecting shape on the piezoelectric element 19 side.

### 4 Other Features 4

In the present embodiment, the protective film 30 that covers at least a portion of the piezoelectric element 19 is provided on a side of the diaphragm 21 opposite to the pressure chamber space 22a, and as illustrated in FIG. 9, the protective film 30 is laid from an outer side toward an inner side of the pressure chamber 22 to a position Pa-1. Therefore, when the pressure chamber 22 is viewed in plan view from the diaphragm 21 side, the protective film 30 covers the extension portion 61 from the outer side to the inner side of the pressure chamber 22. In this manner, since the protective film 30 is extended to the position overlapping with the extension portion 61, it is possible to alleviate the stress applied to the extension portion 61. In the present embodiment, the protective film 30 includes the stress relieving film 30a which is the first protective film and the regulating film 30c which is the second protective film, but only one of these films may be provided. In addition, the two protective films do not have to completely overlap with each other, and the end of one protective film may be shifted from the end of the other protective film. Of course, the protective film may only partially overlap with the extension portion 61, or does not have to overlap with the extension portion 61.

### 5 Other Features 5

In the configuration illustrated in FIG. 9, the protective film 30 is laid to a position covering the extension portion 61 in plan view, but at the same time, the protective film 30 may overlap with at least a leading end portion of the opening portion 28a corresponding to the first region. In this manner, the protective film 30 overlaps with at least the leading end portion of the opening portion 28a, and thus it is possible to alleviate the stress applied to the leading end portion of the opening portion 28a. Of course, the protective film 30 may be provided beyond the leading end portion, or may be configured not to overlap with the opening portion 28a. The protective film 30 can alleviate the stress applied to each portion, but may suppress the displacement when the piezoelectric element 19 is driven. For this reason, the extending position Pa-1 of the protective film 30 may be nonlinear, may be provided long in the -x direction at a position corresponding to the opening portion 28a, and may be formed moderately at a position corresponding to the active portion AR of the piezoelectric element 19, and thus the displacement amount of the piezoelectric element 19 is secured, and the stress applied to the diaphragm 21 is alleviated.

### 6 Other Features 6

In the configuration illustrated in FIG. 9, the protective film 30 is provided from the outer side to the inner side of the pressure chamber 22 to a position covering at least the extension portion 61, and the protective film 30 is also provided so as to overlap with at least the leading end portion of the opening portion 28a. Here, the extension portion 61 and the opening portion 28a, both of which are covered with the protective film 30, may be configured such that the extension portion 61 does not overlap with the leading end of the opening portion 28a in the x direction as illustrated in FIG. 9 when the pressure chamber 22 is viewed in plan view from the diaphragm 21 side. In this manner, when the piezoelectric element 19 is driven and the diaphragm 21 vibrates, it is possible to suppress a situation in which an excessive stress is applied to the extension portion 61 due to the deformation of the opening portion 28a provided as an arm portion which is easily deformed and the extension portion 61 breaks or cracks.

As this feature, that is, as a configuration in which the extension portion 61 does not overlap with the leading end of the opening portion 28a in the x direction, as illustrated in FIG. 9, a positional relationship in which the extension portion 61 and the opening portion 28a overlap with each other when viewed in the y direction while being separated from each other in the x direction is also included, in addition to a positional relationship in which the extension portion 61 and the opening portion 28a do not directly overlap with each other in plan view. In the illustrated example, when viewed in the y direction in a range LY, the extension portion 61 and the opening portion 28a have a positional relationship of overlapping with each other. The extension portion 61 being provided at a position overlapping, in the y direction, with the leading end of the opening portion 28a in the x direction means that, in other words, in the x-y plane in which the extension portion 61 and the opening portion 28a are viewed in plan view in the-z direction, when a range of values on the x axis that can be taken by the extension portion 61 is compared with a range of values on the x axis that can be taken by the opening portion 28a, there is a range of the same value.

The position of the opening portion 28a with respect to the extension portion 61 may vary due to manufacturing errors. Depending on the variation, the leading end of the opening portion 28a may be close to the extension portion 61. When the distance between the opening portion 28a and the extension portion 61 is reduced due to manufacturing variations or the like, the possibility of breakage or cracking at the leading end of the opening portion 28a or in the extension portion 61 is increased. At this time, for example, as illustrated by a two dot chain line in FIG. 9, when the opening portion 28a is provided at a position not overlapping with the extension portion 61 even when viewed in the y direction, even if the position of the opening portion 28a varies in the x direction or the y direction due to manufacturing errors, it is possible to further suppress the occurrence of breakage or cracking at the leading end of the opening portion 28a or in the extension portion 61.

### 7 Other Features 7

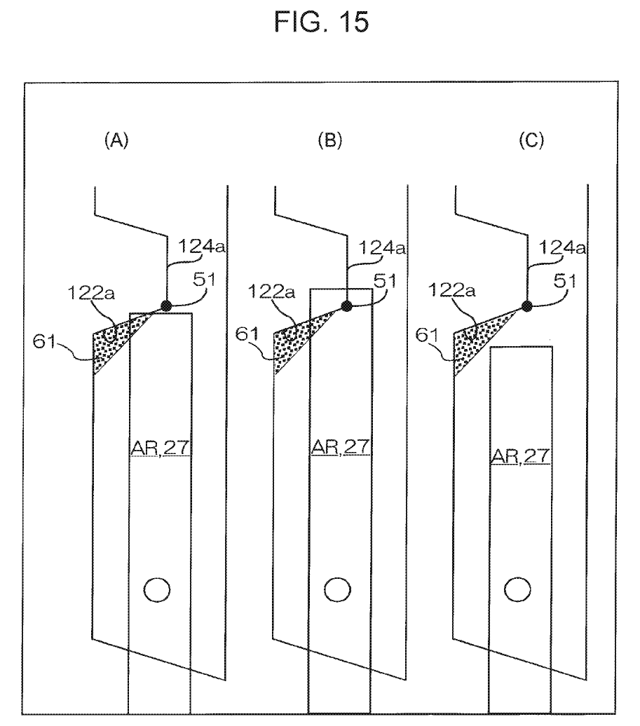

In the above-described embodiment, as illustrated in FIG. 13, the lower electrode 27 that defines the active portion AR is disposed at a position separated from the first pressure chamber side wall 122a by the separation distance Dx and not overlapping with the extension portion 61. As the arrangement of the active portion AR, other than the arrangement described above, for example, as illustrated in FIG. 15, various arrangements are possible. FIG. 15 illustrates three typical arrangements, taking the above-described embodiment as an example. Here, the active portion AR is a portion where the piezoelectric layer 28 is interposed between the lower electrode 27 and the upper electrode 29 in the piezoelectric element 19. In FIG. 15, the lower electrode 27 corresponding to the active portion AR is indicated by an outline for easy understanding of the positional relationship with other members.

As illustrated in FIG. 15, when the pressure chamber 22 is viewed in plan view, the active portion AR, that is, the lower electrode 27 here, can be disposed at a position overlapping with a portion of the first pressure chamber side wall 122a, which is a side wall on the pressure chamber 22 side that forms the corner portion 51, and not overlapping with the corner portion 51, at an end portion in the first direction (the x direction), which is the longitudinal direction of the piezoelectric element 19. This is the arrangement of (A) in FIG. 15. With this arrangement, the stress applied to the extension portion 61 is alleviated by the protective film, and the active portion AR does not overlap with the corner portion 51, so that the stress from the active portion AR is not applied to the corner portion 51. For this reason, it is possible to suppress breakage or cracking of the piezoelectric element 19 from a portion of the corner portion 51.

The end portion of the lower electrode 27, which is the active portion AR, on the flow path 24 side can be disposed to overlap with the corner portion 51. This is the arrangement illustrated in (B) in FIG. 15. In this manner, the stress applied to the extension portion 61 can be dispersed. That is, since the lower electrode 27 is extended onto the first pressure chamber side wall 122a, a fixed end of the lower electrode 27 is located on the first pressure chamber side wall 122a, so that the stress applied to the extension portion 61 can be dispersed. (C) in FIG. 15 is illustrated for comparison and is the same as the arrangement of the above-described embodiment. In this case, as described above, a predetermined distance can be provided between a portion of the lower electrode 27, in which the stress is concentrated, and the extension portion 61, and the stress transmitted to the extension portion 61 can be alleviated. In addition, since the lower electrode 27 does not overlap with the pressure chamber side wall 122, it is possible to suppress so-called crosstalk in which the stress transmitted to the side wall 122 is reduced and the stress is transmitted to the adjacent pressure chamber 22.

Each of the above-described features 1 to 7 may be implemented independently, or two or more features may be implemented in combination. In addition, in a second embodiment and the like which will be described below, appropriate combinations can be made in the same manner.

### B. SECOND EMBODIMENT

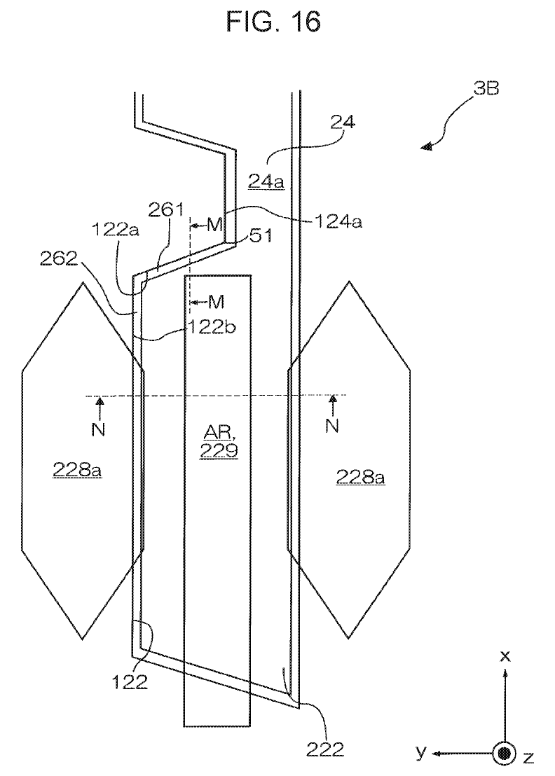

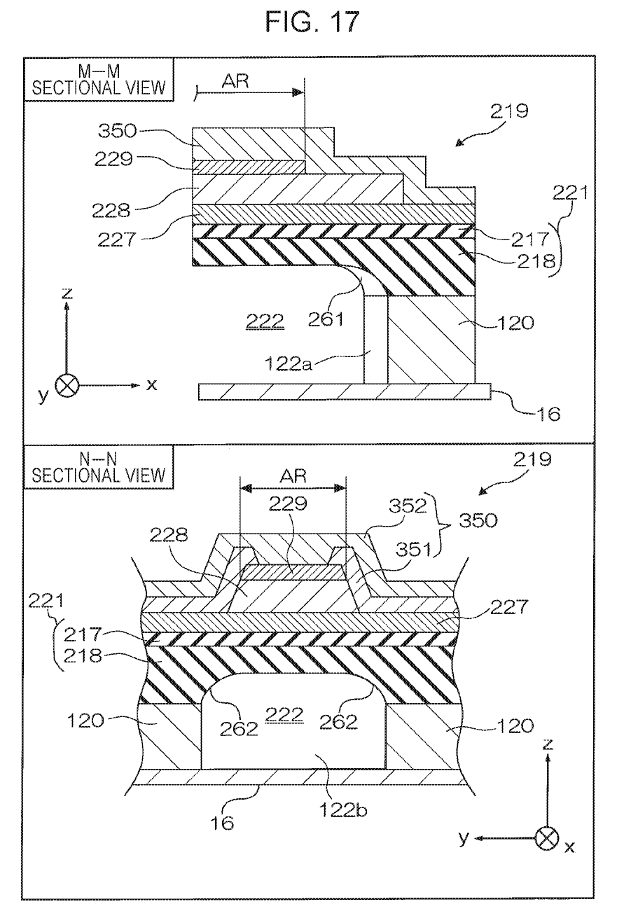

Next, a configuration of a liquid ejecting head 3B according to the second embodiment will be described with reference to FIGS. 16 and 17. FIG. 16 is an explanatory plan view illustrating a configuration around a pressure chamber 222 of the second embodiment, and FIG. 17 is an explanatory view illustrating a configuration around the pressure chamber 222 of the second embodiment in an M-M cross-section and an N-N cross-section in FIG. 16. The liquid ejecting head 3B of the second embodiment is different from the liquid ejecting head 3 of the first embodiment in that a lower electrode 227 is used as a common electrode instead of the upper electrode 19 and that the pressure chamber 222 is formed of two members in a stacking direction of a piezoelectric element 219.

First, a configuration of the piezoelectric element 219 will be described with reference to FIG. 17. In the liquid ejecting head 3B of the second embodiment, the lower electrode 227 is used as a common electrode. As illustrated in FIG. 17, the lower electrode 227 as a common electrode is continuously formed in the second direction (the y direction) on a diaphragm 221 formed of an elastic film 217 and an insulator film 218, and an individual piezoelectric layer 228 and an upper electrode 229 are formed thereon. In this example, a protective film 350 including a stress relieving film 351 and a regulating film 352 made of a metal film is provided to cover the piezoelectric element 219 so that end portions of the upper electrode 229 and the piezoelectric layer 228 in the x direction are not exposed. End surfaces of the piezoelectric layer 228 and the upper electrode 229 in the x direction are protected by the protective film 350.

In the piezoelectric element 219 of the present embodiment, among the insulator film 218 and the elastic film 217 which constitute the diaphragm 221, the elastic film 217 is formed of silicon dioxide (SiO₂), and the diaphragm 221 has a form in which a portion to come into contact with the pressure chamber side wall 122 is thickened in the downward direction. A portion connecting a flat portion serving as the elastic film 217 and the pressure chamber side wall 122 (a vertical surface) is formed as a pair with the elastic film 217 as a rounded portion 261 having a predetermined radius. Therefore, an abutting portion between the elastic film 217 and the pressure chamber side wall 122 has a recessed shape when viewed from the pressure chamber 222 side over substantially the entire circumference of the pressure chamber 222. The rounded portion 261 is one form of an extension portion. Therefore, referring to FIG. 16, in plan view from the diaphragm 221 side, the end portion of the active portion AR on the x direction side (the end portion of the upper electrode 229 on the x direction side in the figure) overlaps with the rounded portion 261, and the protective film 350 is provided from an outer side to an inner side of the pressure chamber 222 to a position covering at least the extension portion 261. For this reason, when the piezoelectric element 219 which is the active portion AR is driven, it is possible to reduce the possibility of breakage or cracking in the extension portion 261 due to the displacement of the piezoelectric element 219 or the vibration of the diaphragm 221 accompanying the displacement.

Also in the second embodiment, opening portions 228a as the first region where the piezoelectric layer 228 is not present on the diaphragm 221 are provided on both sides of the piezoelectric element 219 in the second direction. In the second embodiment, since the lower electrode 227 is used as a common electrode and the upper electrode 229 is used as an individual electrode, the upper electrode 229 does not exist in each opening portion 228a. As illustrated in FIG. 16, when the pressure chamber 222 is viewed in plan view from the diaphragm 221 side, the opening portion 228a of the liquid ejecting head 3B overlaps with a portion of the second pressure chamber side wall 122b which is present in the second direction (the y direction) among the pressure chamber side walls 122 which define the pressure chamber 222. Since the piezoelectric layer 228 is not present on the diaphragm 221, the opening portion 228a is easily deformed. For this reason, when the piezoelectric element 219 is driven, the diaphragm 221 is largely bent in the opening portion 228a.

On the other hand, the opening portion 228a is disposed so as not to overlap with a leading end portion of the extension portion 261 in the first direction (the -x direction). For this reason, similarly to the first embodiment, it is possible to suppress the occurrence of breakage or cracking in the diaphragm 221. In the second embodiment, the opening portion 228a overlaps with a portion of the second pressure chamber side wall 122b, and in this overlapping portion, a rounded portion is formed at an end portion of the second pressure chamber side wall 122b on the diaphragm 221 side, similarly to an upper end of the first pressure chamber side wall 122a, and an extension portion 262 is present. Even in this case, the opening portion 228a does not overlap with the leading end portion of the extension portion 261 in the first direction (the -x direction). For this reason, also in the second embodiment, the possibility of cracking or the like in the diaphragm 221 is suppressed by the presence of the extension portion 261. In the second embodiment, it is also possible to adopt a configuration in which the width of the opening portion 228a is decreased so that the opening portion 228a does not overlap with the leading end portion of the extension portion 262 in the second direction (the y direction). In this case, the opening portion 228a may overlap with the extension portion 262 except for the leading end portion. In FIG. 16, the shape of the opening portion 228a is a substantially hexagonal shape elongated in the first direction, but is not limited thereto. The shape of the opening portion 228a is appropriately designed so as not to overlap with at least the leading end portion of the extension portion 261.

In addition, the leading end portion of the extension portion 261 in the first direction (the -x direction) overlaps with the piezoelectric layer 228. Since the piezoelectric layer 228 overlaps with the leading end portion of the extension portion 261, it is possible to alleviate the stress applied to the leading end portion of the extension portion 261.

The extension portion 61 exemplified in the first embodiment has an inclined shape, a cross-section of which is substantially triangular, that is, a shape in which the width of the extension linearly increases toward the diaphragm 21. However, as illustrated in FIG. 17, even when the extension portion 261 is formed as a curved rounded portion on the pressure chamber side, the extension portion 261 has a recessed shape when viewed from the pressure chamber 222 side and has a shape in which the width of the extension increases toward the diaphragm 221. As described above, the extension portions 61 and 261 may be formed such that the width of the extension increases or the thicknesses of the extension portions 61 and 261 decrease as the extension portions 61 and 261 extend, or may be formed such that the extension portions 61 and 261 extend with the same thicknesses. In addition, the thickness of the extension portion 61 may be gradually decreased in a stepwise manner. The extension portions 61 and 261 may have an inclined shape in which the width (thickness) in the z direction at a first point of the end portion of the first pressure chamber side wall 122a on the diaphragm side is larger than the width (thickness) at a second point that is further apart from the first pressure chamber side wall 122a than the first point. In this case, the widths (thicknesses) of the extension portions at other positions apart from the first pressure chamber side wall 122a do not matter. The widths of the extensions of the extension portions 61 and 261 along the surfaces of the diaphragms 21 and 221 increasing toward the diaphragms includes, in addition to the configuration of a triangular shape in cross-section and the configuration of the rounded portion as described above, a relationship in which an envelope obtained by measuring the widths of the extensions of the extension portions 61 and 261 at a predetermined pitch, that is, an average extension width at each predetermined pitch increases toward the diaphragm.

### C. Other Embodiments

(1) The present disclosure can be implemented as a liquid ejecting head described below. For example, the liquid ejecting head is a liquid ejecting head that ejects a liquid from a nozzle by a fluctuation of pressure in a pressure chamber, the liquid ejecting head including a pressure chamber substrate having a pressure chamber space defined by a side wall, a diaphragm constituting one surface of the pressure chamber by overlapping with the pressure chamber substrate and covering at least a portion of the pressure chamber space, and a piezoelectric element including stacking of a lower electrode, a piezoelectric layer, and an upper electrode in order, the piezoelectric element being disposed on a side of the diaphragm opposite to the pressure chamber space, in which in a connecting portion where the diaphragm comes into contact with a first side wall serving as a side wall existing in a first direction that is a longitudinal direction of the pressure chamber space, the pressure chamber substrate includes an extension portion formed toward an inside of the pressure chamber space with a surface of the side wall as a reference, and when the pressure chamber is viewed in plan view from the diaphragm side, a first region, in which the piezoelectric layer is not provided, is provided at a position overlapping with a second side wall serving as a side wall existing in a second direction intersecting with the first direction and not overlapping with a leading end portion of the extension portion on the first side wall.

With this configuration, overlapping between the diaphragm deformed by the piezoelectric element and another member is not discontinuous, and the risk of cracking of the diaphragm due to local tensile stress applied to the diaphragm is not increased. According to the configuration of this aspect, since the extension portion and the first region do not overlap with each other, cracking or the like is less likely to occur in the diaphragm.

(2) In the above-described configuration, the extension portion may include at least one of <1> in the connecting portion, a portion extended from the first side wall in contact with the diaphragm along a surface of the diaphragm, and <2> in the connecting portion, a portion where a thickness of the extension portion is increased over a predetermined range from a central portion of the pressure chamber space toward a portion in contact with the side wall. With this configuration, it is possible to alleviate the stress applied to the diaphragm in the vicinity of the side wall of the pressure chamber regardless of whether the extension portion is provided on the side wall, is provided as a portion of the diaphragm, or is provided on both the side wall and the diaphragm.

In a case where the extension portion includes the portion of <1>, when the pressure chamber or the like is formed by etching a material of the pressure chamber substrate such as a silicon single crystal substrate, a portion which is intentionally left may be used as the extension portion, or the extension portion may be formed as a remaining portion which is generated due to the progress speed of etching of a corner portion. In a case where the extension portion includes the portion of <2>, the extension portion may be formed by making the diaphragm over a predetermined range from a portion in contact with the side wall toward the central portion of the pressure chamber space thicker than other portions. For example, the extension portion may be formed by increasing the thickness toward a portion corresponding to an outer periphery of the pressure chamber space. The predetermined range in which the thickness is increased may be a range of a constant distance from the inside of the pressure chamber space toward the outer periphery of the pressure chamber space, or may be a range different for each direction such as the first direction or a direction intersecting with the first direction. In either case of <1> and <2>, the manufacturing method is not limited. Of course, it is also possible to adopt a configuration other than the above-described aspects, for example, a configuration in which the extension portion is formed by disposing an extension portion forming substrate between the diaphragm and the pressure chamber substrate.

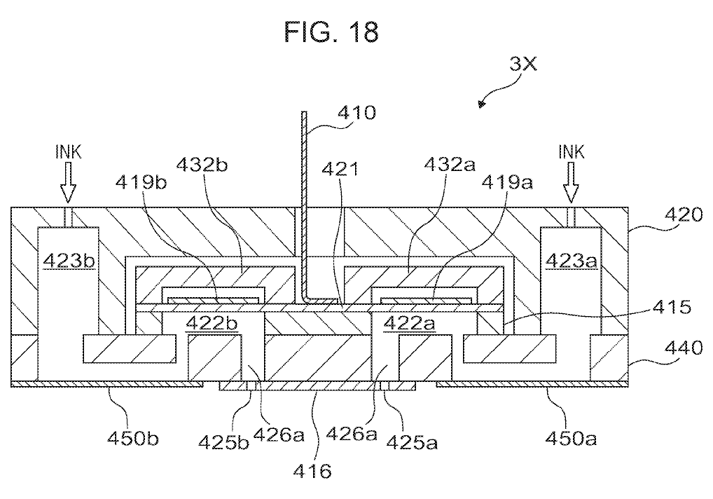

In such a liquid ejecting head, the liquid is ejected from the nozzle by the fluctuation of the pressure in the pressure chamber, but the nozzle does not have to be directly provided in the pressure chamber. In this case, the nozzle may be provided in another space in communication with the pressure chamber. In the above-described embodiments, one surface of the pressure chamber is covered with the nozzle plate. However, in a case where the nozzle is provided in a location different from the pressure chamber, the nozzle plate may be provided separately. For example, a communication substrate having a communication portion that allows the pressure chamber and the nozzle to be in communication with each other may be provided between the pressure chamber substrate and the nozzle plate. An example of such a liquid ejecting head is illustrated in FIG. 18.

A liquid ejecting head 3X here is configured by stacking a communication substrate 440, a pressure chamber substrate 415, and a sealing case 420 in order from the bottom. A groove or an opening portion is formed in each substrate, and a flow path or a pressure chamber is formed by stacking the substrates. A nozzle plate 416 is provided at the lowermost portion of the liquid ejecting head 3X, and two nozzle rows are provided. In the figure, nozzles 425a and 425b are illustrated. Two pressure chambers 422a and 422b and two piezoelectric elements 419a and 419b are provided corresponding to the two nozzles 425a and 425b. The two pressure chambers 422a and 422b are provided with a common diaphragm 421, and the piezoelectric elements 419a and 419b are provided on the diaphragm 421 corresponding to the respective pressure chambers 422a and 422b. The diaphragm 421 may be provided for each of the pressure chambers 422a and 422b. The piezoelectric elements 419a and 419b are accommodated in sealing plates 432a and 432b, respectively. A signal line 410 is connected to the piezoelectric elements 419a and 419b, and a drive signal from the outside can be received.

Reservoirs 423a and 423b are provided at both ends of the liquid ejecting head 3X, are supplied with a liquid, that is, ink here, from an ink cartridge or the like, and store the liquid. Below the reservoirs 423a and 423b, compliance substrates 450a and 450b are provided. Openings in a lower portion of the communication substrate 440 are closed by the compliance substrates 450a and 450b, and thus communication paths are formed in the communication substrate 440. The ink in the reservoirs 423a and 423b is supplied to the respective pressure chambers 422a and 422b via the communication paths. The pressure chambers 422a and 422b are in communication with nozzle flow paths 426a and 426b, respectively, formed in the communication substrate 440, and the nozzle flow paths 426a and 426b are sealed by the nozzle plate 416. Therefore, when the piezoelectric elements 419a and 419b are driven and the pressures in the respective pressure chambers 422a and 422b fluctuate, the pressure fluctuations also occur in the nozzle flow paths 426a and 426b, and ink droplets are ejected from the nozzles 425a and 425b due to the pressure fluctuations.

As described above, the configuration of the pressure chamber or the like of the liquid ejecting head is not limited to the configuration in the above-described embodiments, and various known configurations can be adopted. Here, the ink that has flowed into the nozzle flow paths 426a and 426b from the reservoirs 423a and 423b is eventually ejected from the nozzles 425a and 425b, but it is also possible to adopt a configuration in which the ink is supplied from a reservoir on the supply side to the pressure chambers 422a and 422b and the nozzle flow paths 426a and 426b and is further collected in a reservoir for collection. The collected ink may be circulated between an ink tank and the liquid ejecting head by a pump or the like.

(3) In the above-described configuration, the extension portion formed toward the inside of the pressure chamber space does not have to overlap with the first region in the second direction. With this configuration, even when the positional relationship between the first region and the extension portion varies in the first direction or the second direction due to a manufacturing error and the first region and the extension portion come close to each other, it is possible to further suppress the occurrence of breakage or cracking in the first region or the extension portion.

(4) In the above-described configuration, in a direction of the stacking, the thickness DW of the extension portion on the first side wall may be larger than a total thickness of the diaphragm and the piezoelectric element. With this configuration, since the thickness of the extension portion is larger, it is possible to increase the rigidity of the extension portion, and it is possible to further suppress cracking of the diaphragm.

(5) In the above-described configurations (1) to (4), when the pressure chamber is viewed in plan view from the diaphragm side, an active portion in which the piezoelectric layer is interposed between the lower electrode and the upper electrode does not have to overlap with the leading end portion of the extension portion. With this configuration, there is no member that discontinuously overlaps under overlapping between the active portion and the diaphragm, and local tensile stress is not applied to the piezoelectric layer, or the tensile stress can be suppressed. That is, according to this configuration, it is possible to suppress local tensile stress being applied to the piezoelectric layer.

(6) In the above-described configurations (1) to (5), when the pressure chamber is viewed in plan view from the diaphragm side, a separation distance between the active portion and the second side wall in the second direction may be longer than a separation distance between the active portion and the first side wall in the first direction. With this configuration, the diaphragm can secure a displacement amount in the second direction. The ejection performance of the liquid ejecting head can be secured or improved.

(7) In the above-described configurations (1) to (6), the diaphragm may have a projecting shape toward the pressure chamber when the piezoelectric element is not driven. With this configuration, it is possible to suppress the diaphragm being projecting toward the upper side of the pressure chamber with respect to the pressure chamber when the piezoelectric element is driven. As a result, it is possible to further suppress the stress being applied to the extension portion.

(8) In the above-described configurations (1) to (7), a protective film may be further included, the protective film covering at least a portion of the piezoelectric element on a side of the diaphragm opposite to the pressure chamber space, and the protective film being provided so as to extend from an outer side to an inner side of the pressure chamber and extend to a position covering at least the extension portion, when the pressure chamber is viewed in plan view from the diaphragm side. With this configuration, since the protective film is extended to the position overlapping with the extension portion, it is possible to further alleviate the stress applied to the extension portion.

(9) In the above-described configurations (1) to (8), the protective film may overlap with at least a leading end portion of the first region in the first direction when the pressure chamber is viewed in plan view from the diaphragm side. With this configuration, since the protective film extends to the position overlapping with the first region, it is possible to alleviate the stress applied to the end portion of the first region in the first direction.

(10) In the above-described configurations (1) to (9), the protective film may include a first protective film provided to cover at least a portion of the upper electrode and a second protective film provided on the first protective film and having a higher rigidity than rigidity of the first protective film, with a direction of the stacking as an up-down direction. With this configuration, by providing the second protective film, the stress applied to the leading end of the extension portion can be further alleviated.

The present disclosure is not limited to the above-described embodiments, and can be realized in various configurations without departing from the spirit of the present disclosure. For example, the technical features of the embodiments corresponding to the technical features of the aspects described in the summary of the disclosure can be replaced or combined as appropriate in order to solve some or all of the problems described above or to achieve some or all of the effects described above. In addition, when the technical features are not described as essential in the present specification, the technical features can be appropriately deleted. For example, a portion of the configuration realized by hardware in the above-described embodiments can be realized by software.

What is claimed is:

1. A liquid ejecting head that ejects a liquid from a nozzle by a fluctuation of pressure in a pressure chamber, the liquid ejecting head comprising:
a pressure chamber substrate having a pressure chamber space defined by a side wall;
a diaphragm constituting one surface of the pressure chamber by overlapping with the pressure chamber substrate and covering the pressure chamber space; and
a piezoelectric element including stacking of a lower electrode, a piezoelectric layer, and an upper electrode in order, the piezoelectric element being disposed on a side of the diaphragm opposite to the pressure chamber space, wherein
in a connecting portion where the diaphragm comes into contact with a first side wall serving as a side wall existing in a first direction that is a longitudinal direction of the pressure chamber space, an extension portion is formed toward an inside of the pressure chamber space with a surface of the side wall as a reference, and
when the pressure chamber is viewed in plan view from the diaphragm side, a first region in which the piezoelectric layer is not provided overlaps with a second side wall serving as a side wall a second direction intersecting the first direction, and the first region does not overlap with a leading end portion of the extension portion.

2. The liquid ejecting head according to claim 1, wherein
the extension portion includes at least one of
<1> in the connecting portion, a portion extended from the first side wall in contact with the diaphragm along a surface of the diaphragm, and
<2> in the connecting portion, a portion where a thickness of the extension portion is increased over a predetermined range from a central portion of the pressure chamber space toward a portion in contact with the first side wall.

3. The liquid ejecting head according to claim 1, wherein
the pressure chamber substrate has the extension portion, and
the extension portion extends from the first side wall in contact with the diaphragm along a surface of the diaphragm.

4. The liquid ejecting head according to claim 1, wherein
the diaphragm has the extension portion, and
a thickness of the extension portion is increased over a predetermined range from a central portion of the pressure chamber space toward a portion in contact with the first side wall.

5. The liquid ejecting head according to claim 1, wherein
the extension portion does not overlap with the first region in the second direction.

6. The liquid ejecting head according to claim 1, wherein
in a direction of the stacking, a thickness of the extension portion on the first side wall is larger than a total thickness of the diaphragm and the piezoelectric element.

7. The liquid ejecting head according to claim 1, wherein
when the pressure chamber is viewed in plan view from the diaphragm side, an active portion in which the piezoelectric layer is interposed between the lower electrode and the upper electrode does not overlap with the leading end portion of the extension portion.

8. The liquid ejecting head according to claim 3, wherein
when the pressure chamber is viewed in plan view from the diaphragm side, an active portion in which the piezoelectric layer is interposed between the lower electrode and the upper electrode does not overlap with the leading end portion of the extension portion.

9. The liquid ejecting head according to claim 4, wherein
when the pressure chamber is viewed in plan view from the diaphragm side, an active portion in which the piezoelectric layer is interposed between the lower electrode and the upper electrode does not overlap with the leading end portion of the extension portion.

10. The liquid ejecting head according to claim 7, wherein
when the pressure chamber is viewed in plan view from the diaphragm side, a separation distance between the active portion and the second side wall in the second direction is longer than a separation distance between the active portion and the first side wall in the first direction.

11. The liquid ejecting head according to claim 8, wherein
when the pressure chamber is viewed in plan view from the diaphragm side, a separation distance between the active portion and the second side wall in the second direction is longer than a separation distance between the active portion and the first side wall in the first direction.

12. The liquid ejecting head according to claim 9, wherein
when the pressure chamber is viewed in plan view from the diaphragm side, a separation distance between the active portion and the second side wall in the second direction is longer than a separation distance between the active portion and the first side wall in the first direction.

13. The liquid ejecting head according to claim 1, wherein
the diaphragm has a projecting shape toward the pressure chamber when the piezoelectric element is not driven.

14. The liquid ejecting head according to claim 1, further comprising
a protective film covering at least a portion of the piezoelectric element, wherein
when the pressure chamber is viewed in plan view from the diaphragm side, the protective film is provided so as to extend from an outer side to an inner side of the pressure chamber and overlap with at least the extension portion.

15. The liquid ejecting head according to claim 14, wherein
the protective film overlaps with at least a leading end portion of the first region in the first direction when the pressure chamber is viewed in plan view from the diaphragm side.

16. The liquid ejecting head according to claim 14, wherein
the protective film includes a first protective film provided to cover at least a portion of the upper electrode, and a second protective film provided on the first protective film in a direction of the stacking, the second protective film having a higher rigidity than rigidity of the first protective film.
